(19) United States
(12) Patent Application Publication
(10) Pub. No.: US 2026/0002522 A1
(43) Pub. Date: Jan. 1, 2026

(54) SYSTEMS AND METHODS FOR THE STORAGE OF ENERGY

(71) Applicant: COLD VOLT, INC., Stony Brook,, NY (US)

(72) Inventor: Ramuel MARAMARA, Ronkonkoma, NY (US)

(21) Appl. No.: 19/107,897

(22) PCT Filed: Sep. 1, 2023
(86) PCT No.: PCT/US2023/073267

§ 371 Date: Feb. 28, 2025

Related U.S. Application Data
(60) Provisional application No. 63/403,081, filed on Sep. 1, 2022.

(51) Int. Cl. F03G 3/00

(52) U.S. Cl. CPC F03G 3/094

(57) ABSTRACT

A system for energy storage includes a weight configured to store energy when moved from a first position to a second position, a threaded rod configured to be driven by an energy source and convert rotational motion to linear motion, and a barrel cam configured to couple to the threaded rod and move the weight from the first position to the second position.

### TECHNICAL FIELD

The present disclosure relates generally to the field of energy storage. More specifically, an aspect of the present disclosure provides systems and methods for the storage of potential energy.

### BACKGROUND

Solar photovoltaic systems and wind turbines have added large amounts of power to the grid, but both systems are intermittent sources of energy. To solve this problem, massive amounts of energy storage are needed to supply energy to the grid when these sources are not available.

Accordingly, there is a continuing need to develop energy storage systems.

### SUMMARY

In accordance with aspects of the disclosure, a system for energy storage is presented. The system includes a weight configured to store energy when moved from a first position to a second position; a first threaded rod configured to convert rotational motion to linear motion and move the weight from the first position to the second position; a second threaded rod configured to convert linear motion to rotational motion and be driven by the weight moving from the second position to the first position; a first barrel cam configured to couple to the first threaded rod and move the weight from the first position to the second position; and a second barrel cam configured to couple to the second threaded rod and rotate the second threaded rod as the weight moves from the second position to the first position.

In an aspect of the present disclosure, the system may further include an arm configured to support the first threaded rod and the second threaded rod.

In another aspect of the present disclosure, the system may further include a base configured to support the arm.

In yet another aspect of the present disclosure, the system may further include a first hydraulic motor connected to the first threaded rod and configured to drive the first threaded rod.

In a further aspect of the present disclosure, the system may further include a stopper disposed on an end portion of a connecting shaft configured to prevent each of the barrel cams from moving along each of the threaded rods.

In a further aspect of the present disclosure, each of the barrel cams may include a locking mechanism. The weight may include an aperture configured to enable each of the barrel cams to pass through when the locking mechanism is in a released position.

In yet a further aspect of the present disclosure, the system may further include one or more rollers and/or balls disposed on an interior surface of each of the barrel cams in a helical configuration.

In a further aspect of the present disclosure, each of the threaded rods may include threads. The rollers and/or balls may be configured to track the threads as each of the threaded rods rotates.

In yet a further aspect of the present disclosure, the system may further include a finger disposed on an exterior of each of the barrel cams configured to engage with and support the weight as the weight traverses the threaded rod.

In accordance with aspects of the disclosure, a method for energy storage includes imparting rotational motion to a threaded rod in response to an energy source; converting the rotational motion of the threaded rod to linear motion; generating energy by moving a weight from a first position to a second position linearly along the threaded rod; and storing the energy generated in response to movement of the weight to the second position.

In a further aspect of the present disclosure, the method may further include supporting the weight on a barrel cam disposed on the threaded rod.

In a further aspect of the present disclosure, the method may further include connecting the threaded rod to the energy source using a connecting shaft.

In yet a further aspect of the present disclosure, the method may further include preventing further movement of the weight in response to the barrel cam encountering a stopper disposed on an end portion of the connecting shaft.

In a further aspect of the present disclosure, the stored energy may be converted to electrical energy by moving the weight from the second position to the first position.

In accordance with aspects of the disclosure, a system for energy storage is presented. The system includes a weight configured to store energy when moved from a first position to a second position; an energy source configured to source and/or sink energy in response to movement of the weight from at least one of the first position to the second position or the second position to the first position; a threaded rod configured to be driven by the energy source and convert rotational motion to linear motion, the threaded rod including threads, wherein the threaded rod includes a hydrostatic screw, a hydrodynamic screw, a ball screw, a roller screw, and/or a coated screw; a barrel cam configured to couple to the threaded rod and move the weight from the first position to the second position, wherein the barrel cam includes a roller or a ball disposed on an interior surface of the barrel cam configured to track the threads of the threaded rod as the threaded rod rotates; and a connecting shaft configured to connect the threaded rod to the energy source, wherein the connecting shaft is configured to transfer rotational motion from the energy source to the threaded rod and vice versa. The weight is raised with one threaded rod configuration and lowered with a different threaded rod configuration.

Further details and aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a front perspective view of a system for energy storage, in accordance with aspects of the disclosure;

FIG. 2 is a side perspective view of the system of FIG. 1, in accordance with aspects of the disclosure;

FIG. 3 is a top perspective view of the system of FIG. 1 in accordance with aspects of the disclosure;

FIG. 4 is an alternate front perspective of the system of FIG. 1 in accordance with aspects of the disclosure;

FIG. 5 is an enlarged view of an arm portion of the system of FIG. 1 in accordance with aspects of the disclosure;

FIG. 6 is an enlarged view of the arm portion of the system of FIG. 1 as shown in FIG. 5, with a weight of the system of FIG. 1 depicted as transparent, in accordance with aspects of the disclosure;

FIG. 7 is a further enlarged view of the arm portion of the system of FIG. 1 as shown in FIG. 6, with a barrel cam depicted as transparent to display rollers mounted therein, in accordance with aspects of the disclosure;

FIG. 8 is an enlarged, top perspective view of the system of FIG. 1 in accordance with aspects of the disclosure;

FIG. 9 is an enlarged view of an arm portion of the system of FIG. 1, with an arm of the system of FIG. 1 depicted as transparent to display stoppers mounted thereon, in accordance with aspects of the disclosure;

FIG. 10 is a further enlarged view of the arm portion of the system of FIG. 1 as shown in FIG. 9, in accordance with aspects of the disclosure;

FIG. 11 is a side perspective enlarged view of another example aspect of the arm portion of the system of FIG. 1, in accordance with aspects of the disclosure;

FIG. 12 is an enlarged side view of another example aspect of a locking mechanism of the system of FIG. 1, in accordance with aspects of the disclosure;

FIG. 13 is a crossection view of a barrel cam of the system of FIG. 11, in accordance with aspects of the disclosure;

FIG. 14 is a perspective cutaway view of rollers of the barrel cam of FIG. 13, in accordance with aspects of the disclosure;

FIG. 15 is a block diagram of a system for storing energy using the system 100 of FIG. 1, in accordance with aspects of the disclosure;

FIG. 16 is a side perspective partial view of the top support bearing of the system of FIG. 11, in accordance with aspects of the disclosure;

FIG. 17 illustrates segmented joints of the system 100 of FIG. 11, in accordance with aspects of the disclosure;

FIG. 18 illustrates a support for the segmented joints of the threaded rod of the system 100 of FIG. 11, in accordance with aspects of the disclosure;

FIG. 19 is a side, partial view which illustrates the segmented joints of the threaded rod in accordance with aspects of the disclosure;

FIGS. 20A-20D illustrate the segmented joint of the threaded rod, in accordance with aspects of the disclosure;

FIG. 21 is a side perspective view of a hydraulic power takeoff unit of the system of FIGS. 1 and 11, in accordance with aspects of the disclosure;

FIGS. 22 and 23 illustrate side perspective cutaway views of the hydraulic motor of FIG. 21, in accordance with aspects of the disclosure;

FIG. 24 is a schematic diagram of another example aspect of a system for energy storage, in accordance with aspects of the disclosure;

FIG. 25 is a perspective, partially cut away view of the generator and motor of FIG. 24, shown from the generator side perspective for use with the energy storage system of FIG. 1, in accordance with aspects of the disclosure;

FIG. 26 is a perspective, partially cut away view which shows the motor of FIG. 24 connected to the generator for use with the energy storage system of FIG. 1, in accordance with aspects of the disclosure;

FIG. 27 is a perspective view of another example aspect of a system for energy storage, in accordance with aspects of the disclosure;

FIG. 28 is a perspective view of another example aspect of a system for energy storage, in accordance with aspects of the disclosure;

FIG. 29 is an enlarged perspective view of the system of FIG. 26 shown on an incline, in accordance with aspects of the disclosure;

FIG. 30 is a perspective view of a system for energy storage, where the system includes several connected systems of FIG. 1, in accordance with aspects of the disclosure;

FIG. 31 is a perspective view of a system for energy storage, where the system is a self-supported assembly made up of several connected systems of FIG. 1, in accordance with aspects of the disclosure;

FIG. 32 is a perspective view of a system for energy storage, where the system is an assembly made up of an array of several connected systems of FIG. 1, in accordance with aspects of the disclosure;

FIG. 33 is a perspective view of a system for energy storage, in accordance with aspects of the disclosure; and

FIG. 34 is a perspective view of a system for energy storage, where the system is an assembly made up of several connected systems of FIG. 33, in accordance with aspects of the disclosure.

### DETAILED DESCRIPTION

The present disclosure relates generally to the field of energy storage. More specifically, an aspect of the present disclosure provides systems and methods for the storage of energy.

Aspects of the present disclosure are described in detail with reference to the drawings wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

The disclosed technology stores energy hourly, daily, weekly, or even seasonally to allow intermittent renewable energy to be a complete power source, and/or to store energy from any source to provide resiliency, reduce electricity cost, reduce transmission cost, provide frequency or voltage regulation, provide black starts, or other benefit. The disclosed technology has the benefit of replacing chemical batteries that have problems with safety, ecological damage, access to exotic metals, and limited life. In addition, the disclosed technology provides cost savings by smoothing peaks and valleys in energy demand. Energy storage can also reduce the need for additional power plants or transmission lines. The disclosed technology adds resiliency to the power grid when power is disrupted by weather, accidents, equipment failure, or natural or man-made disasters. The disclosed technology may maximize available space by being, for example, embedded in a building and/or sunk completely or partially underground. The disclosed technology stores energy in the elevation gain of the weights. The disclosed technology may be configured for small energy storage applications or may have about one or more GWhrs of capacity.

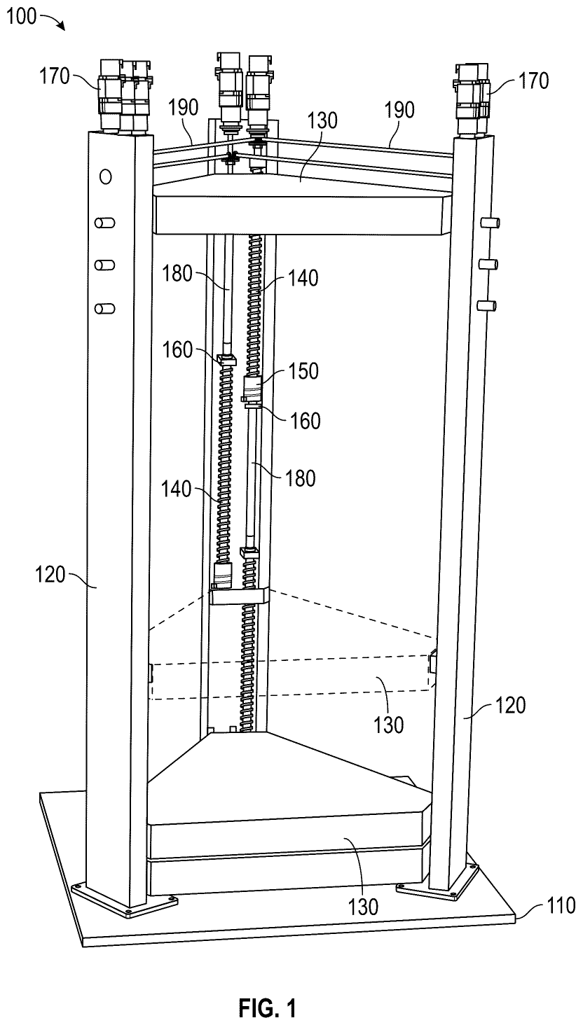

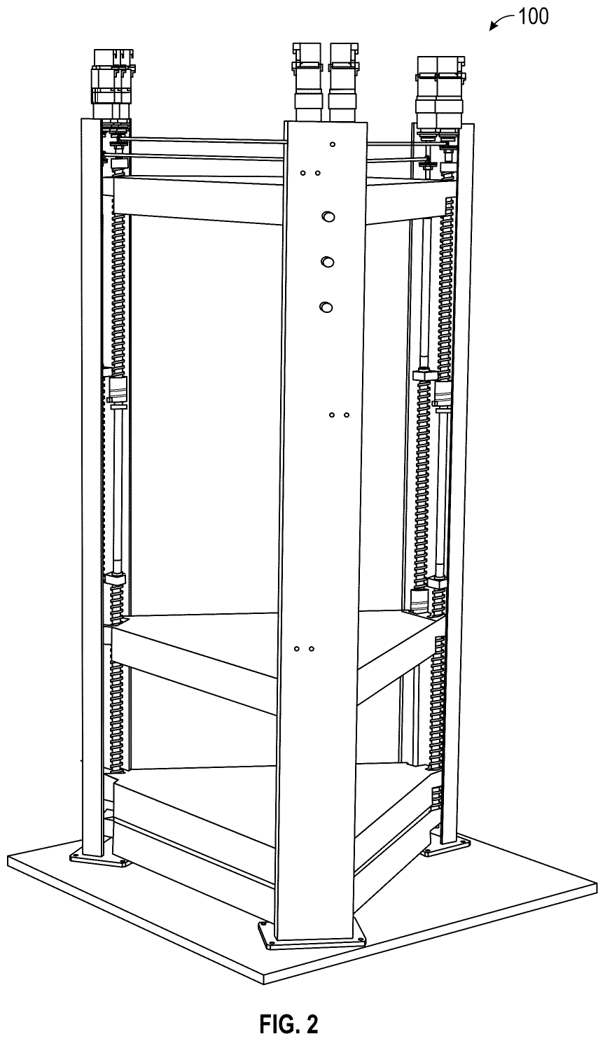

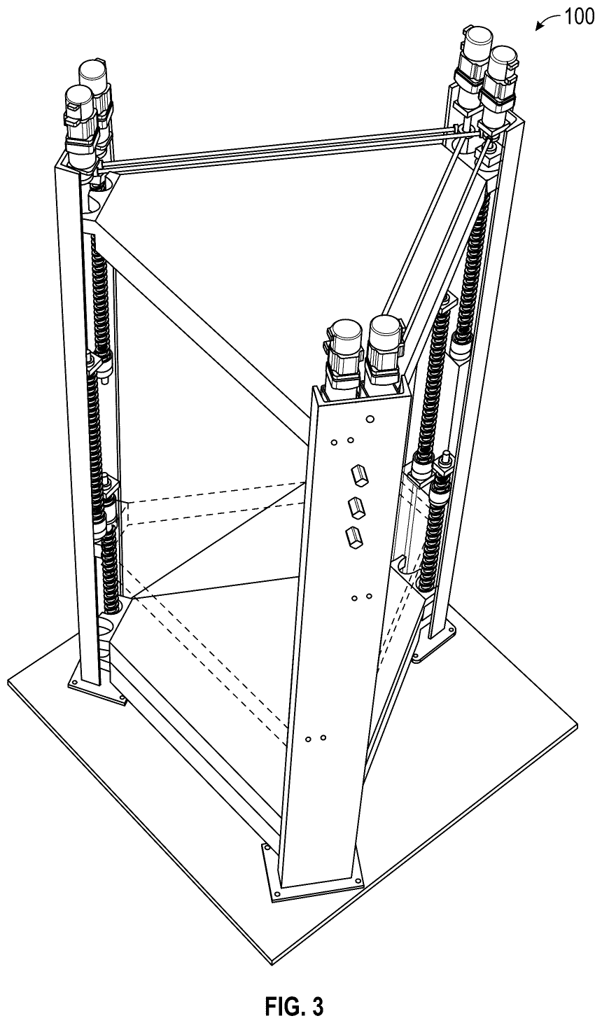

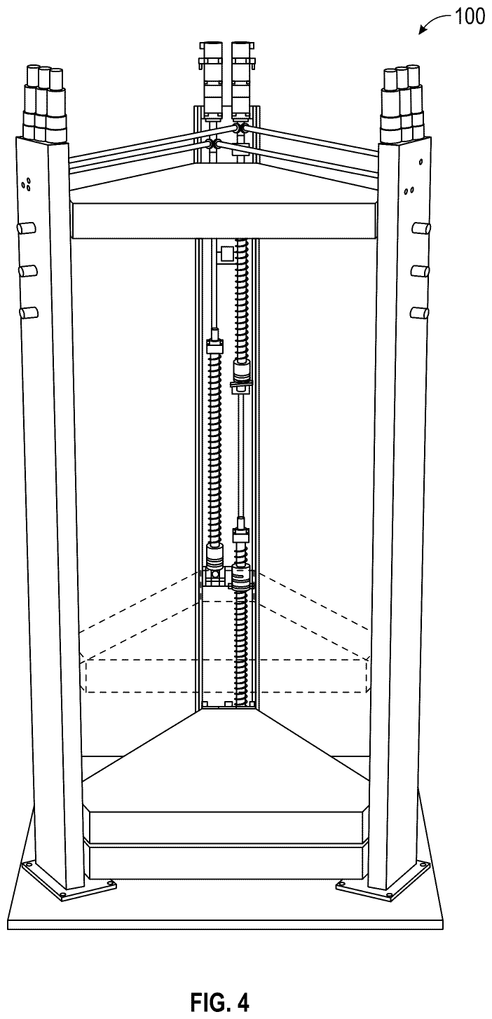

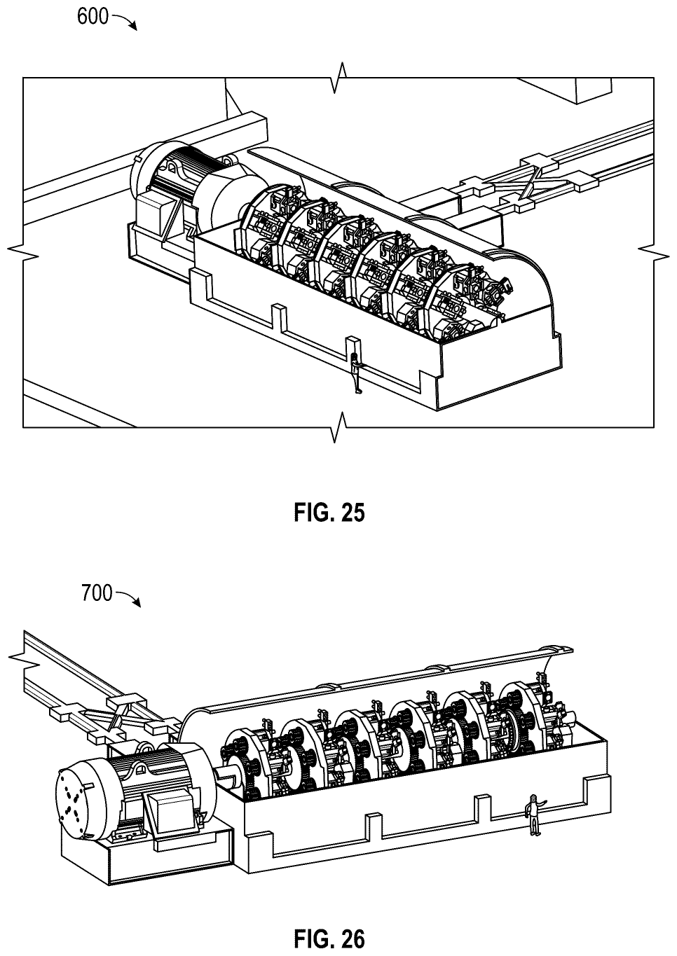

Referring to FIGS. 1-4, a system 100 for energy storage is shown. The system 100 (i.e., a cold-volt gravity battery) is configured to convert electrical energy into potential energy using one or more threaded rods 140 or a series of threaded rods. The system 100 generally includes one or more arms 120, a base 110 configured to support the one or more arms 120, one or more weights 130, one or more threaded rods 140, and an energy source 170. In aspects, energy source 170 may source and/or sink energy. In aspects, system 100 may be configured to connect with a generator 600 (FIG. 25).

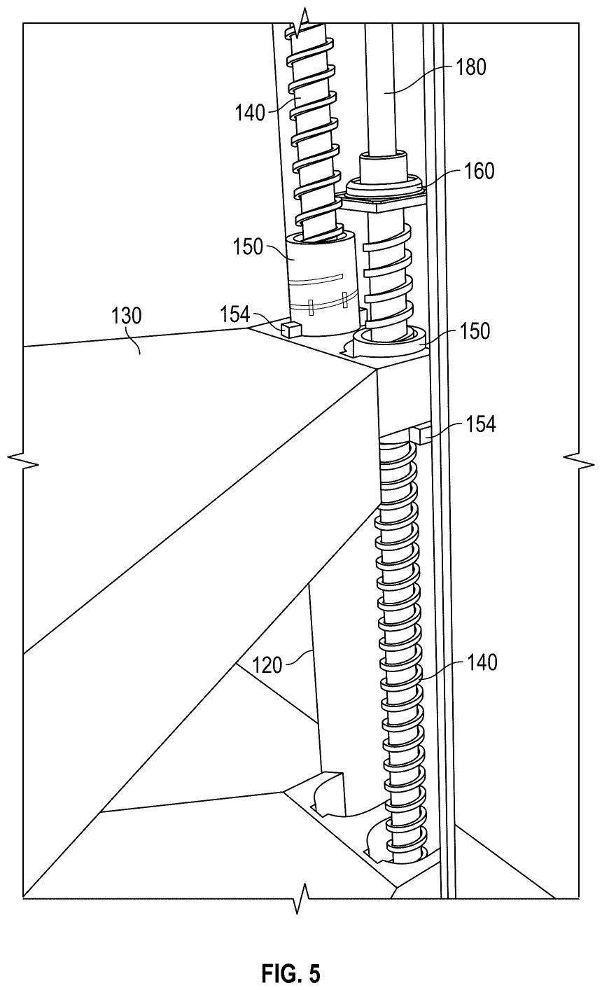

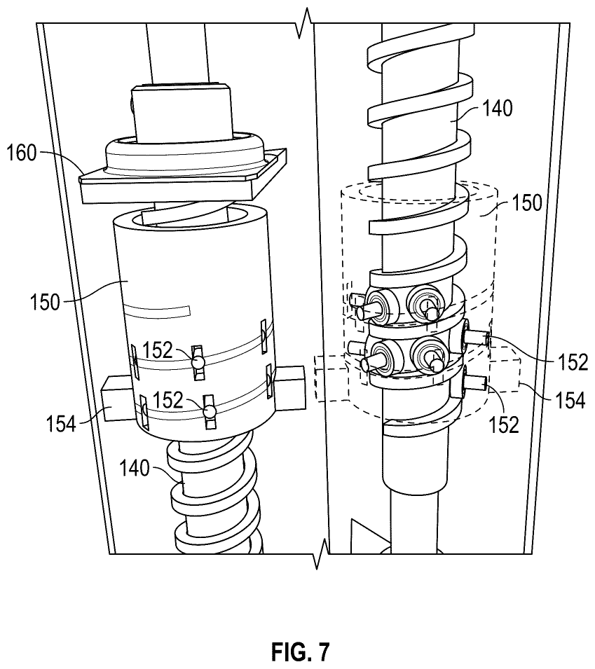

Referring to FIGS. 5-7, disposed along a surface of each of the one or more arms 120 are one or more threaded rods 140. The one or more arms 120 are disposed on base 110. Base 110 may be any suitable shape, for example, triangular, square, and/or circular.

Threaded rod 140 is configured to transfer the rotational motion of an energy source 170 (such as a servomotor) into linear motion (for example, raising or lowering the weight 130). Threaded rod 140 includes threads evenly disposed along a length of threaded rod 140. Threaded rod 140 includes a proximal portion and a distal portion. The threaded rod(s) 140 are configured to move the weight 130 from a first position (starting at the proximal portion) to a second position (ending at the distal portion) in response to rotational motion imparted by the energy source 170. The location of the second position is vertically higher than the location of the first position. Threaded rod(s) 140 are configured to connect to the energy source 170 and connecting shaft 180 (FIG. 5). Connecting shaft 180 is configured to connect to the energy source 170 (FIG. 1) and threaded rod 140. The connecting shaft 180 is configured to transfer rotational motion from the energy source 170 to threaded rod 140 and vice versa. System 100 provides the benefit of using very long large threaded rods 140 or a series of segmented threaded rods 140 to easily lift kiloton weights.

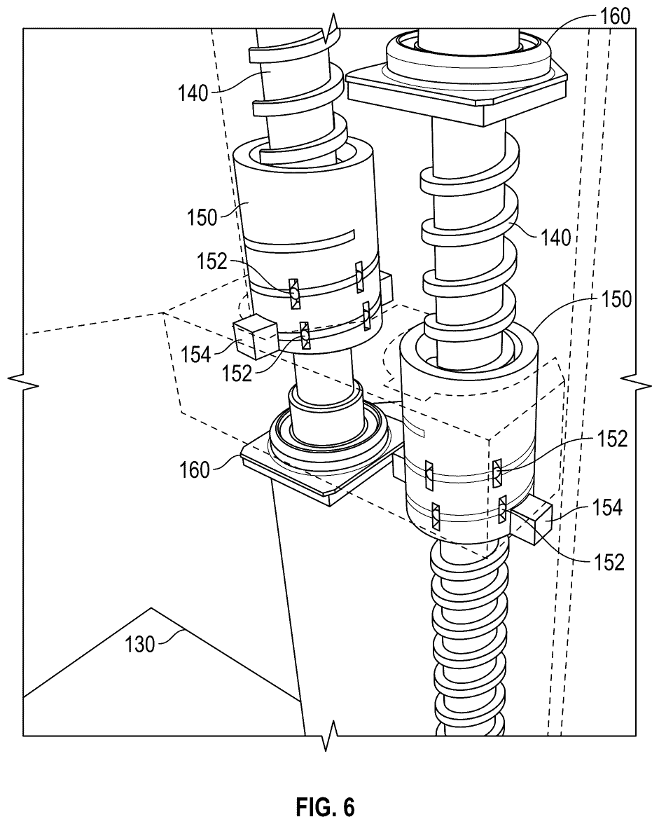

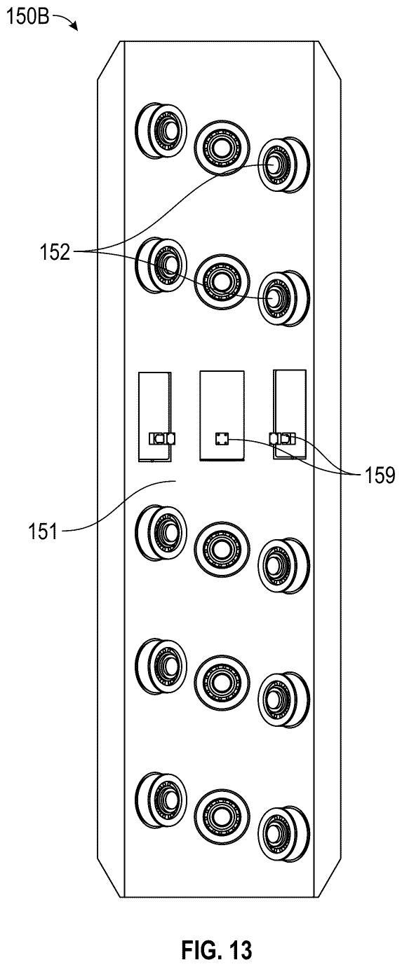

Threaded rod(s) 140 are configured to enable a number of rollers 152 (e.g., a follower) (FIG. 6) that are disposed on an interior surface of a barrel cam 150 (e.g., a rotating nut) to track the threads of threaded rod 140 as threaded rod 140 rotates. Rollers 152 (FIG. 6) are configured to track the threads of threaded rod 140. In aspects, barrel cam 150 (FIG. 13) may include a roller disposed on the interior surface configured to track the threads of threaded rod 140, e.g., a ball screw configuration.

Weight 130 may span to interface with all arms 120. Weight 130 is configured to engage with barrel cam 150 such that a finger 154 of barrel cam 150 may support the weight 130 as the weight traverses threaded rod 140. Weight 130 may be further configured to enable barrel cam 150 to pass through an aperture therein when the barrel cam rotates 90 degrees from its initial position. Weight 130 may include one or more recesses for capturing a finger 154 on barrel cam 150. Weight 130 is contemplated to be any suitable amount of weight. The disclosed technology may utilize different threaded rod and barrel cam configurations for raising and lowering the weight 130. For example, weight 130 may be raised and lowered with the same threaded rod configuration for both the raising and the lowering of weight 130. The weight 130 may be raised with one threaded rod configuration (e.g., a hydrostatic screw and barrel cam configuration) and lowered with a different threaded rod configuration (for example, a ball screw and barrel cam configuration). Additionally, the threads of the threaded rod may be configured differently, e.g., they may be angled differently for a threaded rod configuration to raise the weight 130 versus lowering the weight 130.

The stopper 160 (e.g., a brake) is disposed on an end portion of the connecting shaft 180 and is configured to prevent barrel cam 150 from rotating and to prevent barrel cam 150 from moving further upwards or downwards along threaded rod 140 after the weight has reached the first or second position. For example, the stopper 160 may be engaged when the weight 130 reaches the second position.

The one or more threaded rods 140 and barrel cam 150 may be, for example, hydrostatic, hydrodynamic, coated (e.g., with polytetrafluoroethylene or other suitable material), a roller screw, a ball screw, or a suitable combination of types. The one or more threaded rods 140 and barrel cam 150 may use rollers, balls, wheel bearings, roller chains, and/or other suitable means to improve the overall efficiency of the system 100. The one or more threaded rods 140 may be fabricated, welded, rolled, cut, ground, or manufactured by other suitable means. The one or more threaded rods 140 and barrel cam 150 may use various types of threads. Each of the one or more threaded rods 140 may be one fabrication or may be made up of multiple segments so as to achieve greater heights.

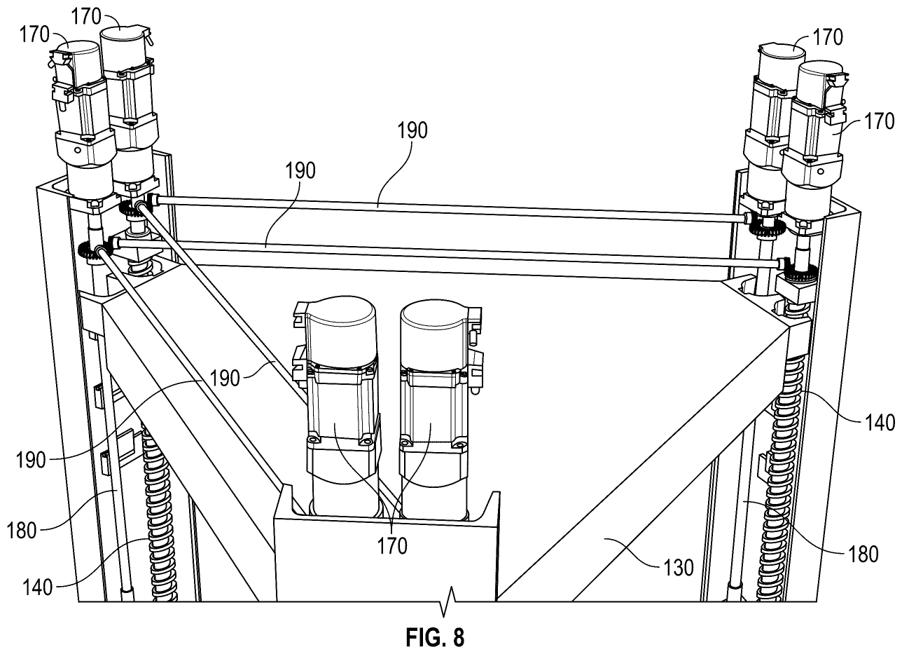

Referring to FIGS. 8-10, the energy source 170 is configured to drive threaded rod 140 by rotating the connecting shaft 180. The energy source 170 may include, for example, a motor, a generator, a hydraulic motor, and/or a pump. The energy source 170 may be further configured to drive a synchronizer 190 (FIG. 8). The synchronizer 190 is configured to transfer the rotational energy of the energy source 170 to threaded rod 140 and the connecting shaft 180 of each of the one or more arms 120. The synchronizer 190 concurrently rotates threaded rod 140 and the connecting shaft 180, thereby keeping the weight 130 level at all times. The synchronizer 190 may include, for example, a bevel gear, sprockets, a gearbox, and/or a hydraulic synchronizer.

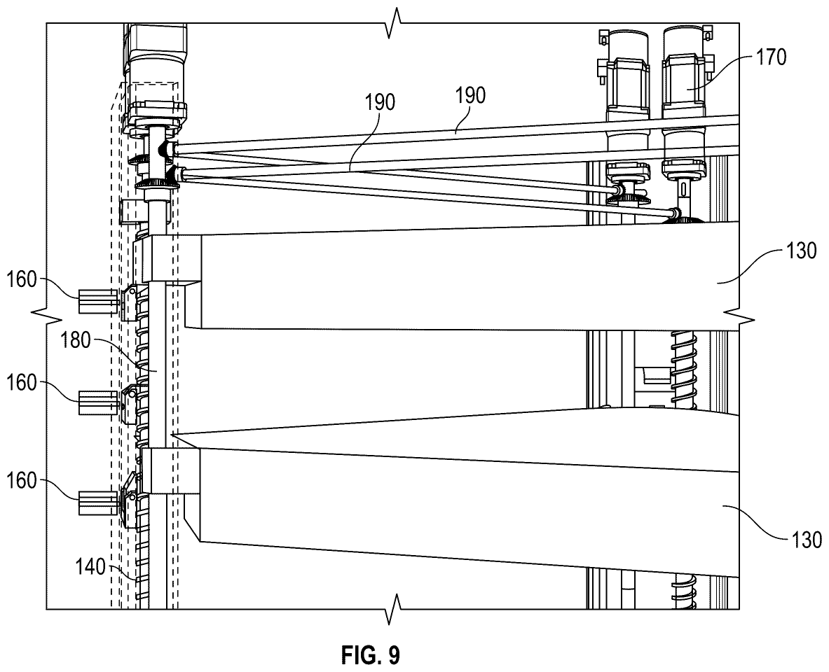

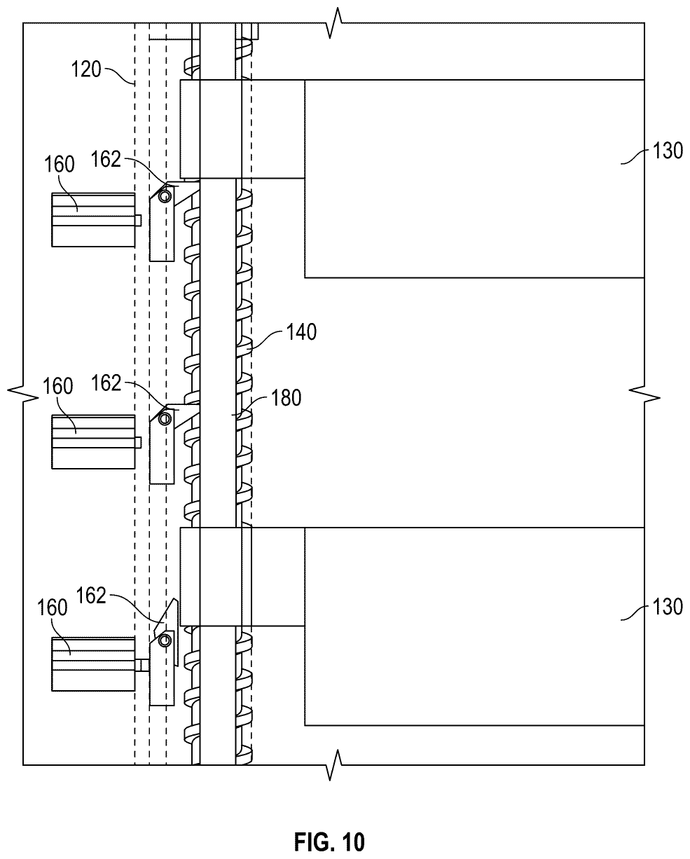

As noted earlier, stopper 160 (FIG. 9) may be engaged when weight 130 reaches the first or second position. When the stopper 160 is engaged, a rod 162 (FIG. 10) of the stopper 160 may be actuated to interface with the weight 130 and lock weight 130 in a position. When rod 162 has locked weight 130 in a position, barrel cam, 150 may rotate and may move upwards or downwards along threaded rod 140 to engage with another weight 130. When disengaged, the stopper 160 may permit rod 162 to release weight 130 from the locked position. The stopper 160 may be engaged electrically, hydraulically, or pneumatically.

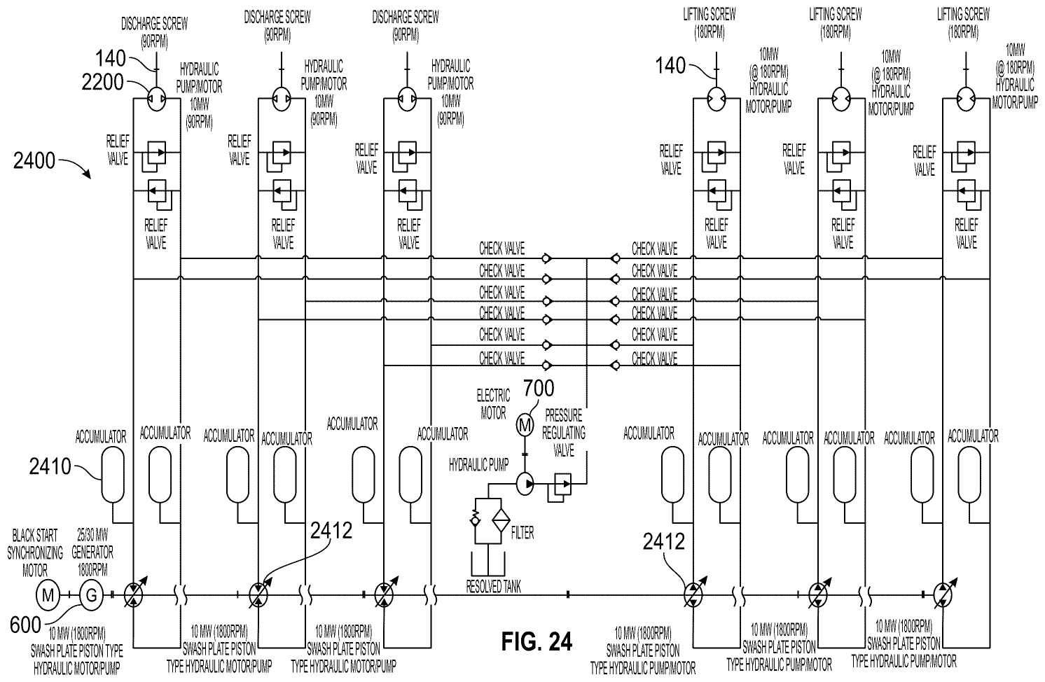

System 100 operates by lifting ultra-heavy loads, (>about 1 kiloton) to very tall heights (>about 200 feet) using low friction screws (for example, threaded rod 140) for the purpose of converting electrical energy into potential energy and vice versa. System 100 stores the electrical energy of the energy source as potential energy by raising the height of one or more weights 130 in response to energy (e.g., electrical energy) being applied by the energy source 170. The stored potential energy may be converted back to electrical energy by enabling weight 130 to start dropping, which causes threaded rod 140 to rotate in response to the linear motion of weight 130. Connecting shaft 180 rotates in response to the rotational motion of threaded rod 140. Connecting shaft 180 then causes the energy source 170 to generate energy (e.g., electrical energy), e.g., by actuating motor 700 (FIG. 24).

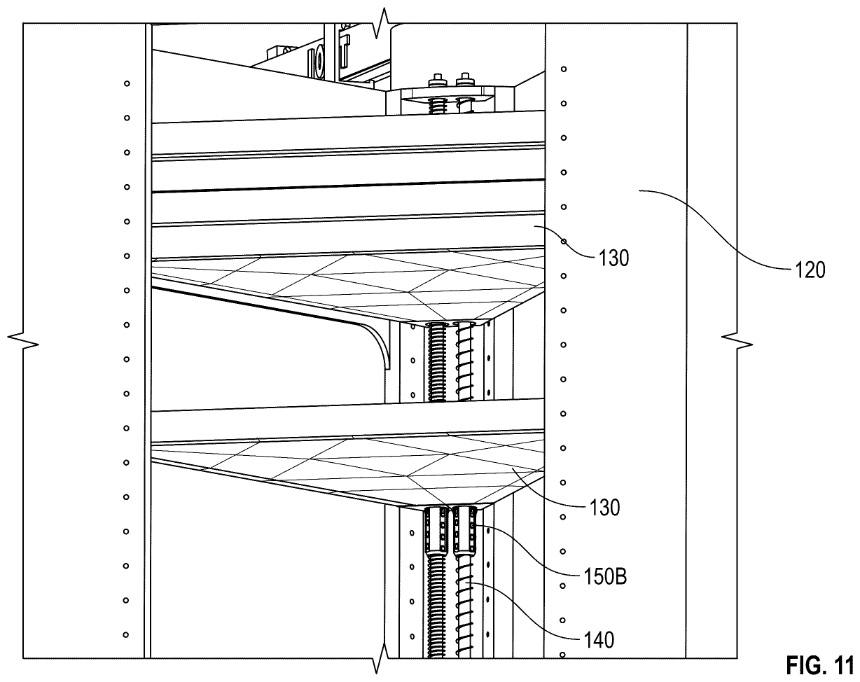

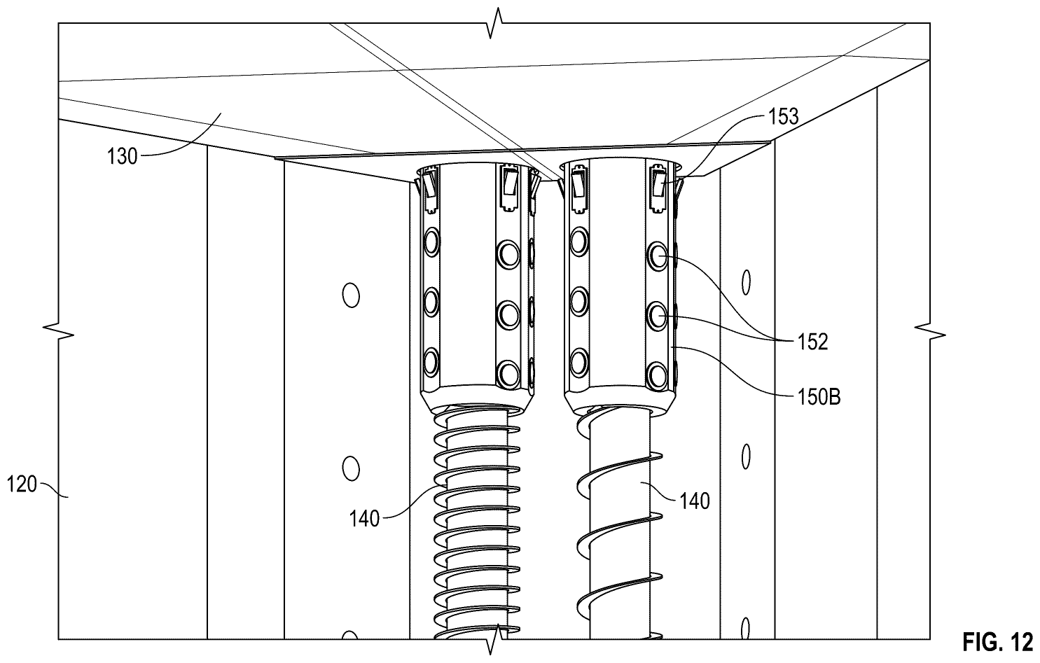

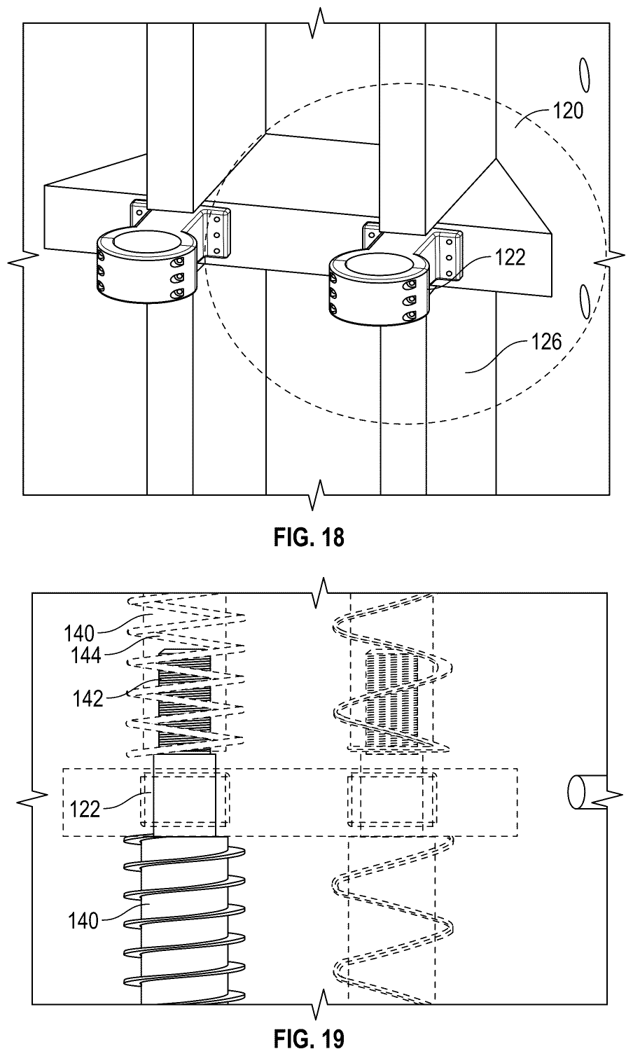

Referring to FIGS. 11-13, another example aspect of the arm of system 100 is shown. Barrel cam 150B includes a number of rollers 152 (e.g., a follower) (FIG. 13) that are disposed on an interior surface 151 of barrel cam 150B to track the threads of threaded rod 140, as threaded rod 140 rotates. Barrel cam 150B may have a “C” shaped cross-section, enabling barrel cam 150B to lock around threaded rod 140 while providing an opening for couplings 122 (FIG. 18) of the arm 120 to pass therethrough.

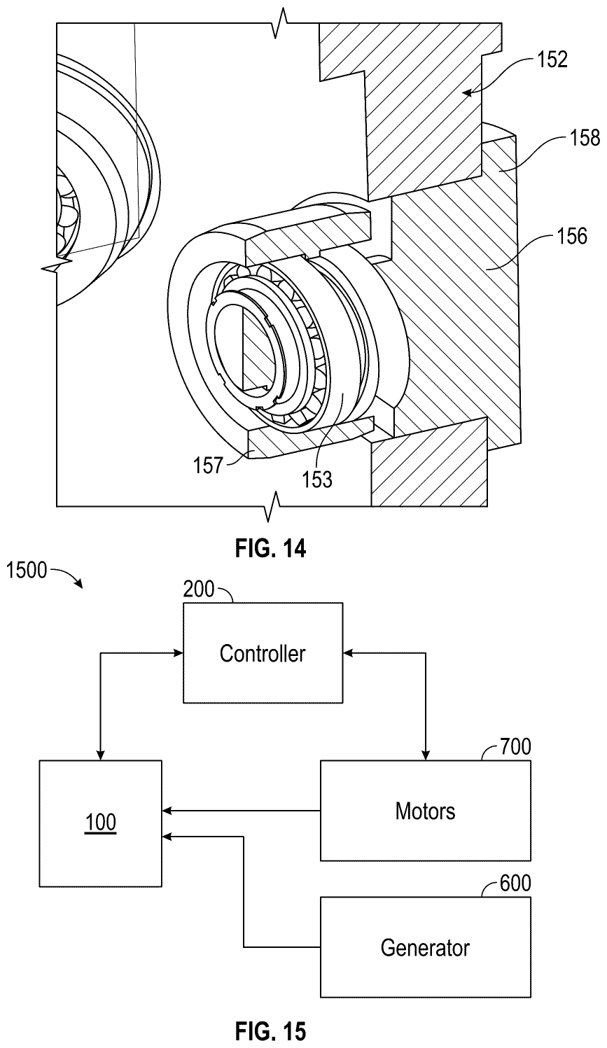

Rollers 152 are arranged to follow the helical pitch of the threads of the threaded rod 140. Rollers 152 are removable and can be serviced from outside of barrel cam 150B. For example, each roller may be about 12″ in diameter and may be rated to carry about 20 tons each. Barrel cam 150B may include a retractable ratchet mechanism 153 located in a middle portion of barrel cam 150B. Rollers 152 of barrel cam 150B are shown in more detail in FIG. 14.

Barrel cam 150B may further include a locking mechanism 159 (e.g., a retractable ratchet mechanism). Locking mechanism 159 is a fail-safe system, so the barrel cam 150B only exerts a lifting force and not a downward force. Locking mechanism 159 is retractable, so it can pass thru multiple weights 130 without engaging the weights 130. Locking mechanism 159 may be a spring-loaded locking mechanism. System 100 may include an actuator (e.g., a weak actuator; not shown) configured to release locking mechanism 159 when system 100 is unloaded (e.g. when the weight 130 is not seated on the threaded rod 140). The actuator may be configured to not release the locking mechanism 159 when it is loaded. The actuator may be controlled by controller 200 (FIG. 15). Locking mechanism 159 may be configured to be spring loaded and operate one way only, i.e., locking only on an up position. Locking mechanism 159 enables barrel cam 150B to pass thru weight 130 as weight 130 descends. This configuration provides the benefit of preventing the pulling of weight 130 down unintentionally.

Weights 130 may be lowered one by one by system 100 (FIG. 11). In aspects, the two threaded rods may have different pitch threads. For example, a high-pitch (e.g., fine thread) threaded rod 140 may be used for lowering weights 130, and a low-pitch (e.g., coarse thread) threaded rod 140 may be used to lift weight 130. For example, the coarse thread may have a pitch of about 45 degrees. The thread pitch of the lifting threaded rod 140 would be determined by back driving torque.

Referring to FIG. 14, a detailed view of rollers 152 of barrel cam 150B of FIG. 13 is shown. Rollers 152 include bearings 153 (i.e., low-friction bearings), a housing 157 (e.g., a removable bearing housing), and a shaft 156. Each of the rollers 152 is supported by bearings 155. Shaft 156 extends from housing 157 and may be locked in place by bearing nuts 158. A suitable grease seal protects the bearings from both sides.

With reference to FIG. 15, a block diagram of a system 1500 for storing energy using system 100 of FIG. 1. System 1500 generally includes system 100 for energy storage, a controller 200, a generator 600, and one or more motors 700. Controller 200 includes a processor and memory. The memory stores instructions, which, when executed by the processor, enable system 1500 to control various functions of system 1500. For example, controller 200 may enable controlling one or more motors 700, generate electricity using the stored potential energy, and/or control the actuator to enable or disable the locking mechanism 159 of FIG. 13. The one or more motors 700 and/or generator 600 may be in communication with the system 100 using, for example, hydraulic fluid and/or gears.

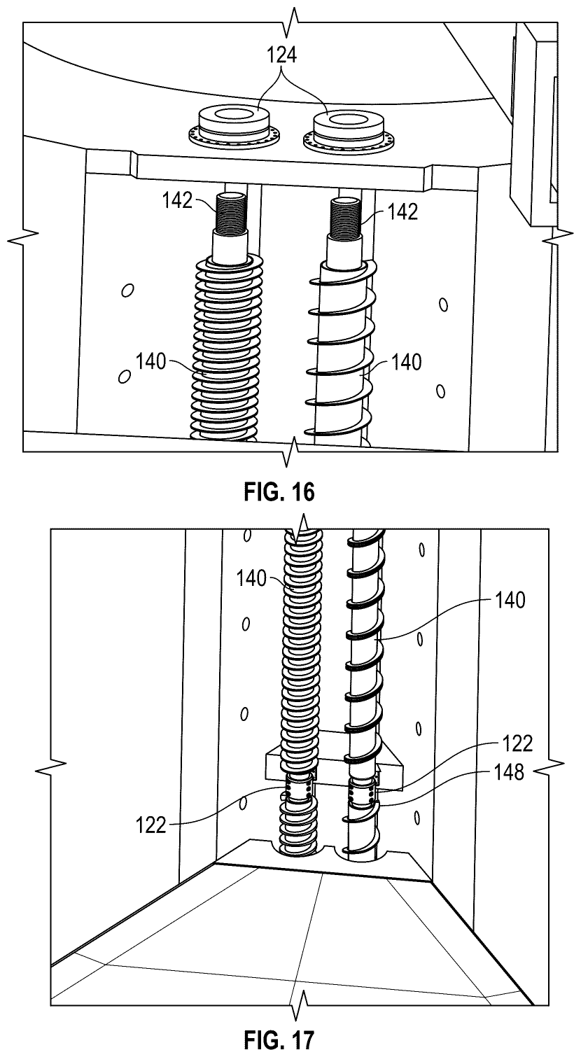

Referring now to FIG. 16, a top perspective view of the top support bearing 124 is shown. Top support bearing 124 carries all the axial load of the segmented threaded rod. Top support bearing 124 is a hydrodynamic bearing. Pressurized hydraulic fluid is introduced between the top and bottom race of top support bearing 124. The introduction of pressurized hydraulic fluid has at least two effects, the top and bottom two races of the top support bearing 124 separate, and the friction goes to zero. When the pressure is removed, the top and bottom races meet again and act as a brake, slowing and stopping the threaded rod from rotating.

Referring to FIG. 17, segmented joints 148 of the system 100 of FIG. 11 are shown. The segmented joints 148 enable several benefits. Generally, threaded rods can only be manufactured to a length that makes transportation and manufacturing effective. Since weight 130 travels from top to bottom of each of the arms 120, it also means that threaded rods 140 need to be the same length. In this application, for example, this length can be several hundred feet long. To facilitate manufacturing and transportation, threaded rod 140 is divided into several segments and joined together on-site. The method of construction stated below enables the effective transfer of axial and torque load. The segmented joint 148 design also enables the two joined threaded rods to be adjusted so that the threaded rod spiral/threads are lined up. This provides the benefit of enabling barrel cam 150B to transition or pass thru the two joined threaded rods 140.

Referring to FIG. 18, a support 122 (intermediate bearing) for segmented joint 148 of threaded rod 140 is shown. Support 122 is mounted on the arm 120. Support 122 may be integrally formed in arm 120, or may be attached using suitable fasteners (e.g., threaded rods and/or bolts). Support 122 is configured to receive and support segmented joint 148 and to enable barrel cam 150B to traverse segmented joint 148. Support 122 provides support in the radial direction only and carries no axial load. The length of support 122 is less than the length of the threaded rod joint, so the threaded rod assembly is free to stretch axially, due to load or to thermal expansion. Arm 120 may include a guide 126 configured to prevent barrel cam 150B from rotating. A portion of support 122 may have the same width as guide 126.

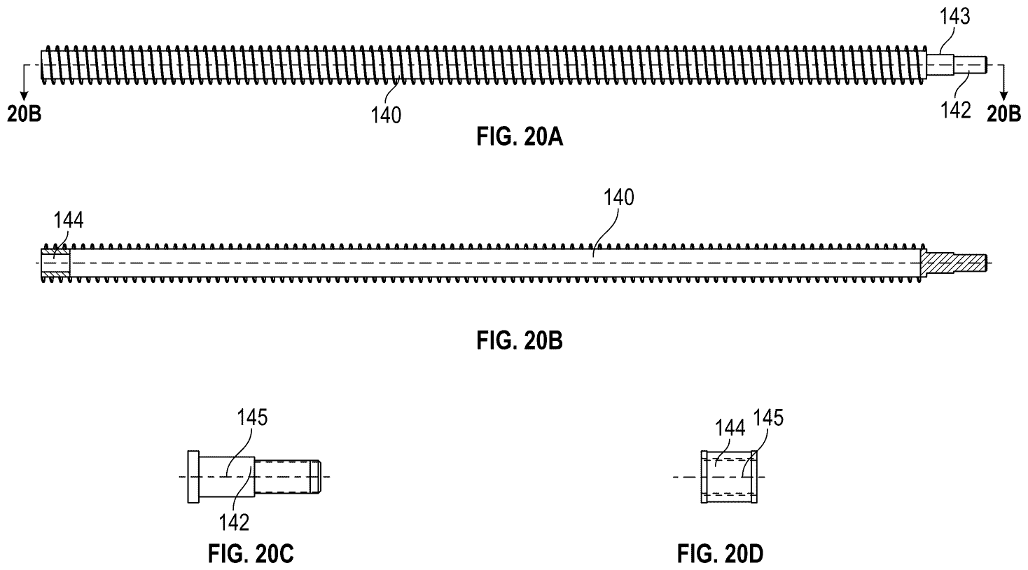

FIGS. 19 and 20A-20D illustrate segmented joint 148 of threaded rod 140. Segmented joint 148 of threaded rod 140 (FIG. 20A) includes a threaded socket 144 (FIG. 20D), a smooth bearing surface 143 (FIG. 20C), a hole 145 for a locking pin (not shown), and a threaded shaft 142 (e.g., a fine threaded stud) configured to thread into threaded socket 144 of another threaded rod 140. These parts may be integrally formed or constructed using other suitable methods. For example, threaded socket 144 (FIG. 20C) may be a threaded hole insert that may be welded to the threaded rod 140. The two threaded rods 140 may then be threaded into each other. The two threaded rods 140 are aligned and a locking pin (not shown) may be inserted to secure the two threaded rods 140 together.

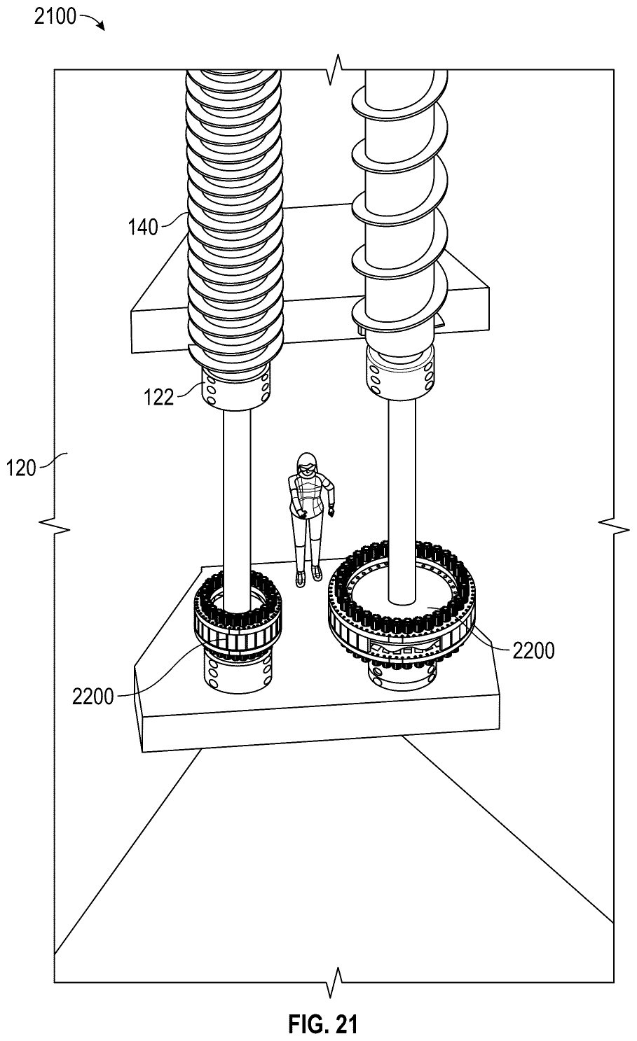

FIG. 21 illustrates a side view of a hydraulic power takeoff unit 2100 of system 100 of FIGS. 1 and 11. The threaded rods 140 drive or are driven by one or more reversible hydraulic motors 2200 (FIG. 24) and/or a pump. When the weights 130 are being lifted, both threaded rods 140 are driven by hydraulic motors 2200. When weights 130 are descending, the threaded rods 140 drive or turn the two hydraulics pumps (not shown).

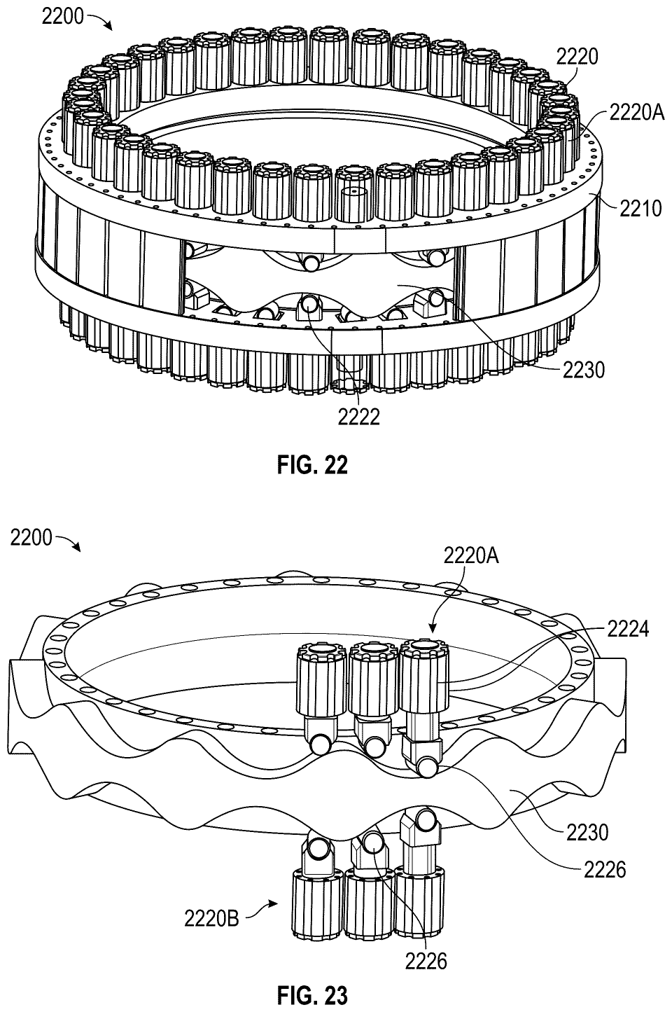

FIGS. 22 and 23 illustrate a top perspective cutaway view of the hydraulic motor 2200 of FIG. 21. Hydraulic motor 2200 generally includes a radial cam 2230 (e.g., a cam-shaped rotor) and a plurality of hydraulic drive stators 2220. Hydraulic motor 2200 provides the benefit of efficiently handling megawatt power levels. The radial cam 2230 may include multiple cam profiles. For example, radial cam 2230 may be made of about ten cam profiles.

The hydraulic drive stator 2220 is divided into an upper cylinder assembly 2220A and a lower cylinder assembly 2220B. Upper cylinder assembly 2220A and lower cylinder assembly 2220B alternate in movement using a valve system tied to the cam rotor 2230. Upper cylinder assembly 2220A and lower cylinder assembly 2220B each include housing 2228 that contains a pressurized hydraulic fluid, a cylinder 2224 configured to pressurize the hydraulic fluid as cylinder 2224 is actuated by the radial cam 2230, and a roller 2226 (e.g., bearing) configured to ride along a face of the radial cam 2230.

The cylinders 2224 each take turns in pushing against the face of the radial cam 2230, causing the radial cam 2230 to move. For example, a pure sinusoidal cam shape paired with three cylinders will produce an even torque output.

Referring to FIG. 24, a schematic of another example aspect of a system 2400 for energy storage is shown. Each of the hydraulic motors 2200 drive one threaded rod 140. Hydraulic motors 2200 are operably connected to a generator 600 and/or a motor 700. The system 100 may further include one or more accumulators 2410 (e.g., a battery). The schematic shown is for one “stack” (e.g., a system 100), however, the system 2400 may include any suitable number of “stacks” (e.g., six stacks).

FIG. 25 shows an example generator 600 of system 2400 of FIG. 24. For example, FIG. 25 shows thirty six hydraulic motors 2200 mechanically connected to one generator. For example, system 2400 has six stacks. For example, each stack may be driven by six hydraulic motors 2200 geared together in a disk arrangement.

FIG. 26 shows an example motor 700 (e.g., a hydraulic motor) of system 2400 of FIG. 24. For example, one disk may have six variable speed hydraulic motors 2400 to drive the six hydraulic motors 2200 (FIG. 24) using the threaded rod 140 (FIG. 21). For example, there are six disks for a total of thirty-six hydraulic motors 2200.

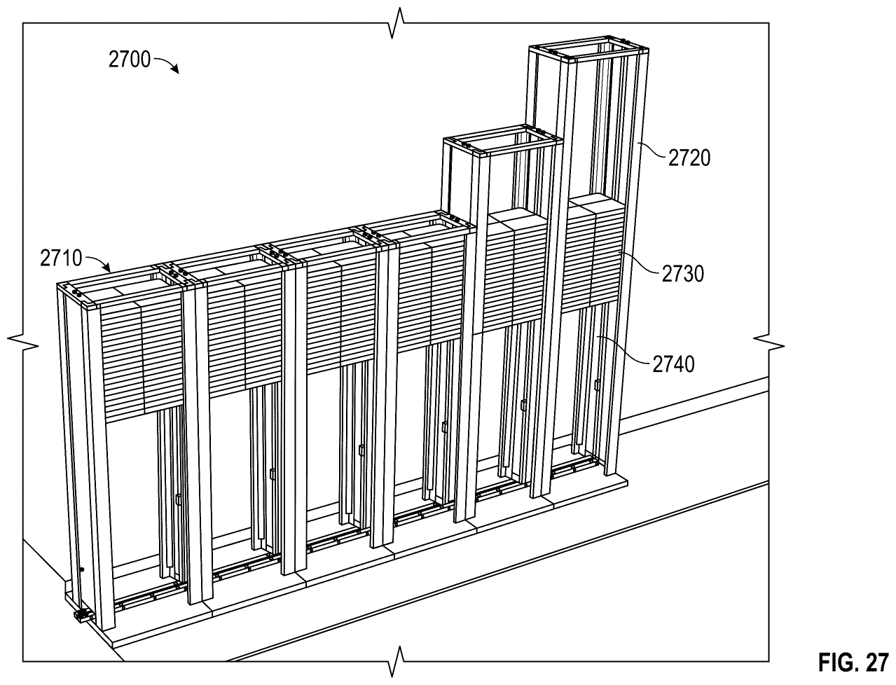

Referring to FIG. 27, another example system 2700 for energy storage, is shown. System 2700 may include several connected systems 2710 for increased energy storage capacity. The system 2700 generally includes one or more arms 2720 supported by the inclined surface, one or more weights 2730, one or more threaded rods 2740, and an energy source (such as motor(s) 700 and accumulators 2430 of FIG. 24). The energy source is configured to drive the one or more threaded rods 2740 and may do so directly and/or via an interconnecting component as is done by the connecting shaft 180 of system 100. The system 2700 operates to store the electrical energy of the energy source by lifting one or more weights 2730 up the inclined surface using one or more threaded rods 2740 in response to energy being applied to the energy source.

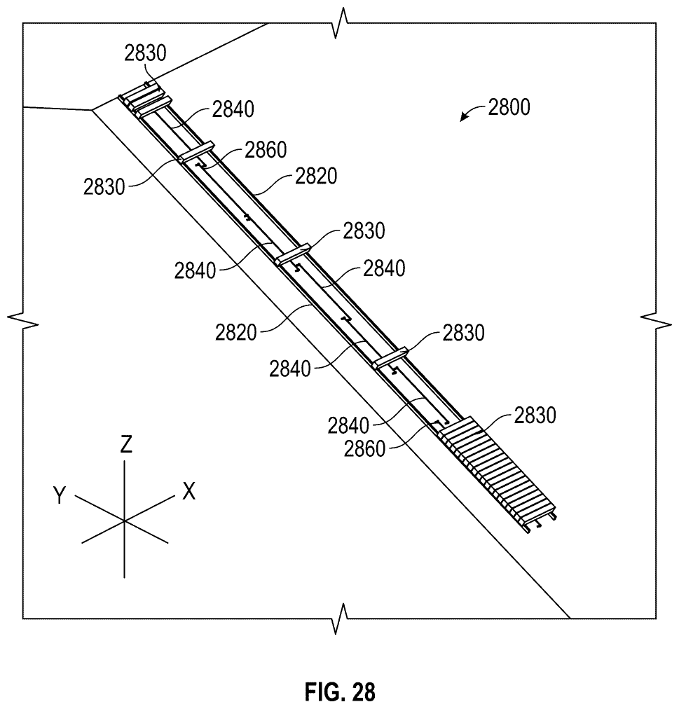

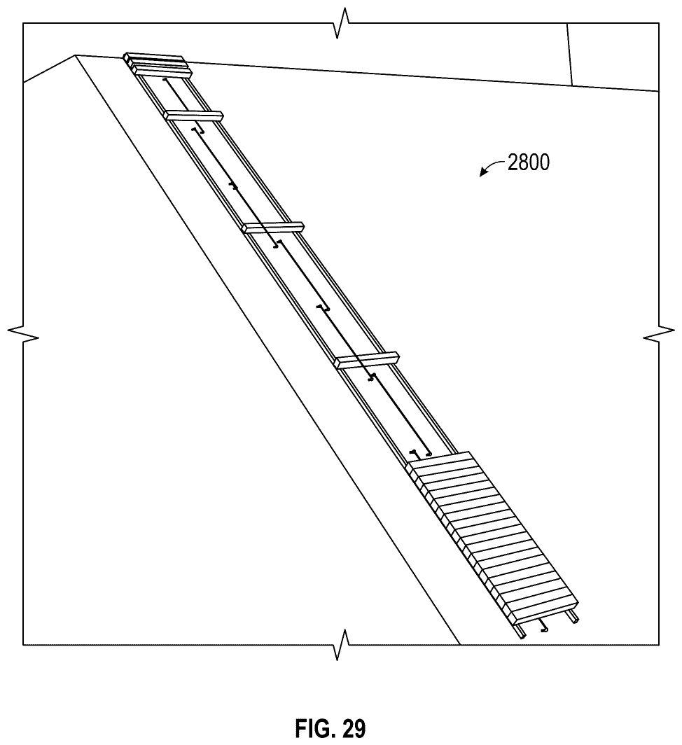

Referring to FIGS. 28 and 29, another example system 2800 for energy storage is shown. System 2800 may operate in a similar manner to system 100 of FIG. 1. System 2800 may be situated on an inclined surface. The inclined surface may be, for example, a ramp, or the side of a hill or mountain. The system 2800 generally includes one or more arms 2820 supported by the inclined surface, one or more weights 2830, one or more threaded rods 2840, and an energy source (such as motor(s) 700 and accumulators 2430 of FIG. 24). The energy source is configured to drive the one or more threaded rods 2840 and may do so directly and/or via an interconnecting component as is done by the connecting shaft 180 of system 100. The system 2800 operates to store the electrical energy of the energy source by lifting one or more weights 2830 up the inclined surface using one or more threaded rods 2840 in response to energy being applied to the energy source.

The threaded rods 2840 run along the inclined surface. The one or more arms 220 are disposed alongside the threaded rods 2840 on the inclined surface. The one or more threaded rods 2840 are configured to move the weight 2830 from a first position to a second position in response to the energy source through the use of a barrel cam (not shown). In aspects, the weight 2830 may span to interface with any and all arms 2820. The weight 2830 may engage with the barrel cam 2850 such that the barrel cam 2850 supports the weight 2830 as it moves up or down the threaded rod 240. The stopper 2860 is connected to the threaded rod 240 and is configured to prevent the barrel cam 2850 from moving. The stopper 2860 is configured to prevent the barrel cam 2850 from moving further upwards or downwards along the threaded rod 2840.

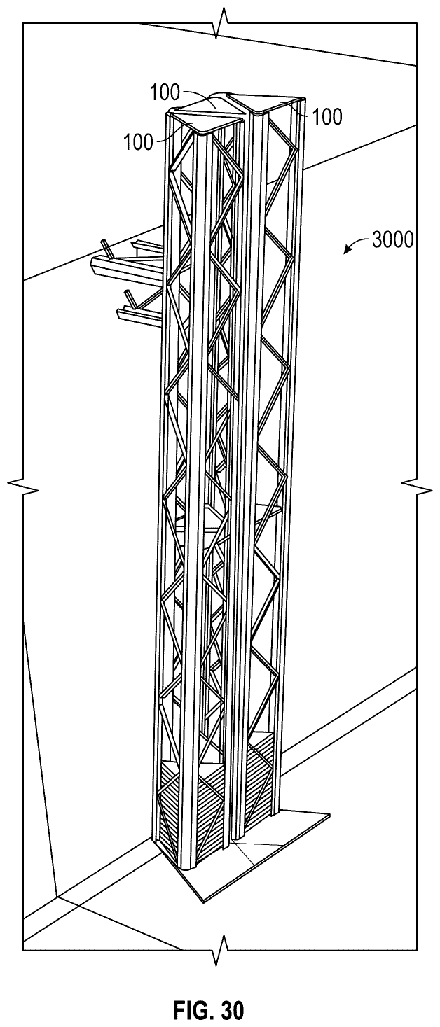

FIG. 30 shows an aspect of a system 300 for energy storage. System 3000 of FIG. 30 may include several connected systems 100 of FIG. 1 for increased energy storage capacity. The system 3000 is shown as being supported partially from the outside.

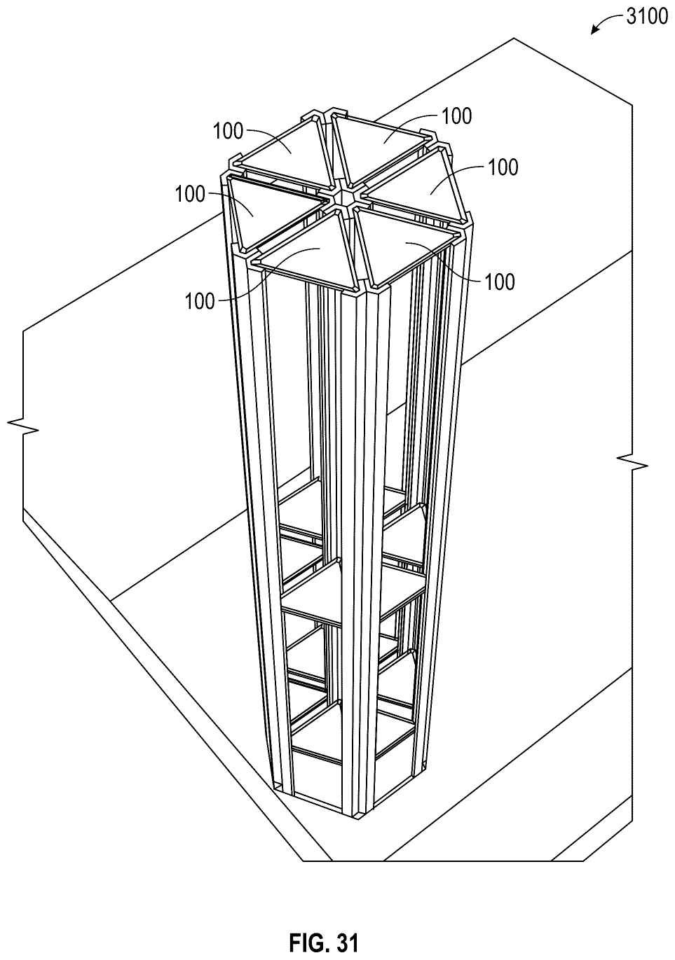

FIG. 31 shows a system 3100 for energy storage. System 3100 is an assembly made up of an array of six of system 100 of FIG. 1. Although six are shown, any suitable number of system 100 may be used for increased energy storage.

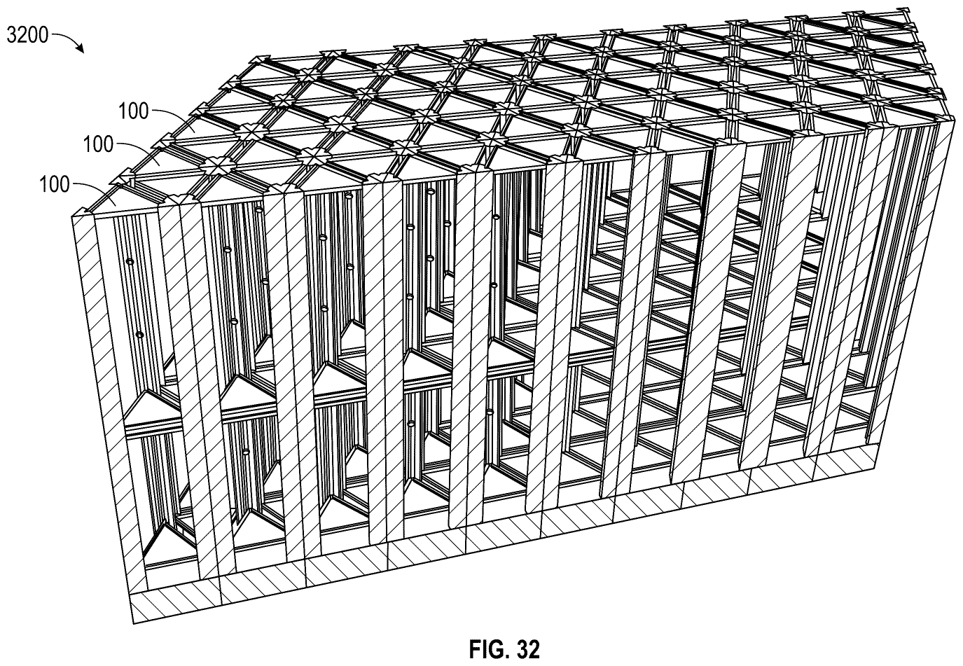

FIG. 32 shows a system 500 for energy storage. System 500 is an assembly made up of an array of many of system 100 of FIG. 1.

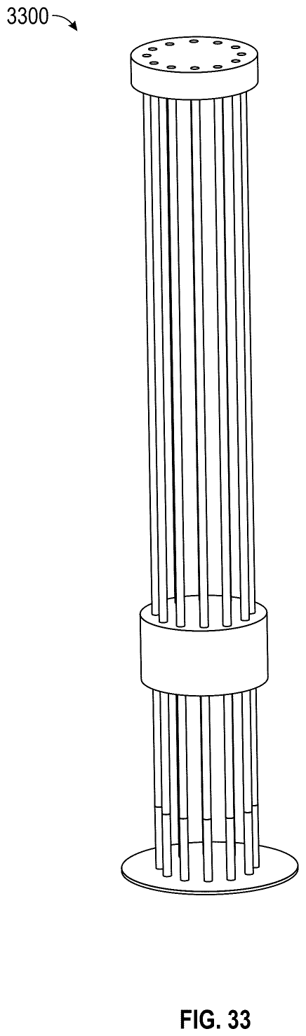

FIG. 33 is a perspective view of a system 3300 for energy storage. The system 3300 includes a circular weight and a circular pattern of one or more threaded rods 140. System 3300 functions in a similar manner to system 100 of FIG. 1. In system 3300, one or more threaded rods 140 may be stationary, and barrel cam 150 may rotate to move the weight 130.

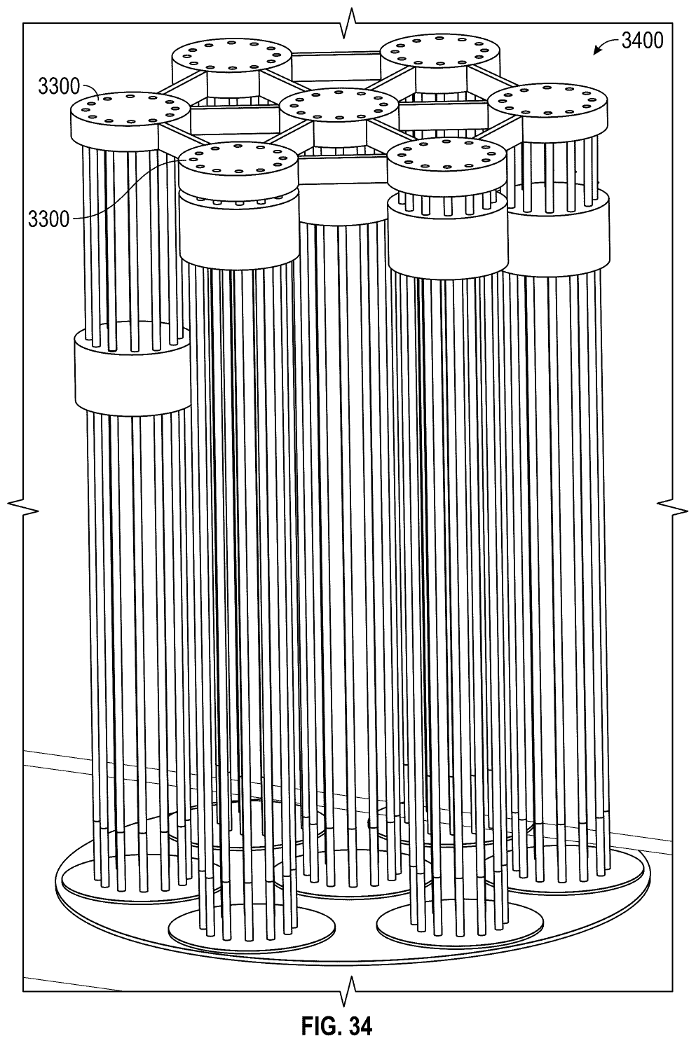

FIG. 34 is an array 3400 of systems for energy storage, where the array 3400 is made up of several connected systems 3300 of FIG. 34, in accordance with aspects of the disclosure.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

1. A system for energy storage, the system comprising:
a weight configured to store energy when moved from a first position to a second position;
a first threaded rod configured to convert rotational motion to linear motion and move the weight from the first position to the second position;
a second threaded rod configured to convert linear motion to rotational motion and be driven by the weight moving from the second position to the first position;
a first barrel cam configured to couple to the first threaded rod and move the weight from the first position to the second position; and
a second barrel cam configured to couple to the second threaded rod and rotate the second threaded rod as the weight moves from the second position to the first position.

2. The system of claim 1, further comprising an arm configured to support the first threaded rod and the second threaded rod.

3. The system of claim 2, further comprising a base configured to support the arm.

4. The system of claim 1, further comprising:
a first hydraulic motor connected to the first threaded rod and configured to drive the first threaded rod.

5. The system of claim 4, further comprising:
a hydraulic motor connected to the second threaded rod and configured to drive a generator.

6. The system of claim 4, further comprising a stopper disposed on an end portion of a connecting shaft configured to prevent each of the barrel cams from moving along each of the threaded rods.

7. The system of claim 1, wherein each of the barrel cams includes a locking mechanism, and
wherein the weight includes an aperture configured to enable each of the barrel cams to pass through when the locking mechanism is in a released position.

8. The system of claim 1, further comprising one or more rollers and/or balls disposed on an interior surface of each of the barrel cams in a helical configuration.

9. The system of claim 8, wherein each of the threaded rods includes threads, and wherein the rollers and/or balls are configured to track the threads as each of the threaded rods rotates.

10. The system of claim 1, further comprising a finger disposed on an exterior of each of the barrel cams configured to engage with and support the weight as the weight traverses the threaded rod.

11.-16. (canceled)
